(19) United States
(12) Patent Application Publication
(10) Pub. No.: US 2022/0178082 A1
(43) Pub. Date: Jun. 9, 2022

(54) METHOD OF PRODUCING A MOLDED FIBER PRODUCT AND MOLDED FIBER PRODUCT

(71) Applicant: Stora Enso OYJ, Helsinki (FI)

(72) Inventors: Sohrab Kazemahvazi, Täby (SE); Ulla Jansson, Karlstad (SE); Irene Wedin, Bromma (SE); Frank Peng, Stockholm (SE)

(73) Assignee: Stora Enso OYJ, Helsinki (FI)

(21) Appl. No.: 17/429,987

(22) PCT Filed: Feb. 12, 2020
(86) PCT No.: PCT/IB2020/051112

§ 371 Date: Aug. 11, 2021

(30) Foreign Application Priority Data
Feb. 12, 2019 (SE) 1950165-9

(51) Int. Cl. D21J 3/00; D21H 11/08; D21H 11/12; D21H 11/20; D21J 1/16; B65D 65/38

(52) U.S. Cl. CPC D21J 3/00; D21H 11/08; B65D 65/38; D21H 11/20; D21J 1/16; D21H 11/12

(57) ABSTRACT

The invention discloses a method for producing a three dimensional molded product from cellulose fibers, comprising the steps of:
providing a cellulose fiber composition comprising 1-30 wt % lignin, said cellulose fiber composition further having a solid content between 0.1-95%;
providing a forming tool having a three dimensional shape including a forming surface, and bringing said forming surface into contact with the cellulose fiber composition; and
press drying the cellulose fiber composition contacted by the forming tool at temperatures>200° C. to a dry content of at least 70%.

The invention also relates to a three dimensional fiber based product obtainable by means of said method.

### TECHNICAL FIELD

The present invention relates to a method of producing a three dimensional cellulose fiber based product by means of fiber molding.

### BACKGROUND

There is a growing interest for producing cellulose based, three dimensional (3D) products, e.g. for use as packaging applications for foodstuff, technical products, electronic equipment and/or consumer goods. Several advantages are associated with the use of natural fibers (such as cellulose fibers) for manufacturing packages. Being a renewable resource, natural fibers provide a sustainable alternative to other packaging materials such as aluminum and plastics, and furthermore natural fibers are both recyclable and biodegradable. Natural fibers include cellulose fibers of any natural origin, such as derived from wood pulp and/or plants.

One way of manufacturing molded fiber products is by thermoforming, e.g. wherein a forming mold is dipped into a pulp suspension followed by compression-molding performed under heat, resulting in a dried fiber product having a shape complementary to the shape of the mold. It is also known to thermoform products such as trays from a cellulose fiber sheet. Forming is then done by stretch-forming the wetted sheet using a pressing tool. The latter option has disadvantages associated with poor flexibility and elasticity of the cellulose sheet material, limiting the 3D-formability and/or leading to the risk of cracks appearing in the material upon forming.

In US2013248130, a compression-molded tray of fiber material coated with a removable film is described, and WO2006057610 also presents a method and a machine for making fiber products such as food trays by means of fiber molding from a stock of pulp.

The requirements on the quality of the pulp material used for manufacturing packaging products are generally set high, as there is a need of high mechanical strength and chemical purity of the end product, e.g. if intended for food packaging. Often, reinforcement pulp and strength chemicals are needed in order to achieve acceptable mechanical properties. Also, the production costs are sometimes expensive, and there are also problems associated with high energy consumption when drying of the products during molding.

### OBJECTS OF THE INVENTION

It is an object of the present invention, to provide a method for molding a three dimensional fiber based product suitable for use in packaging applications, which method is more efficient, less expensive and requires less energy compared to known procedures. It is also an object of the invention to provide a molded fiber based product which has low density yet high mechanical strength.

### SUMMARY

According to the invention, there is provided a method for producing a three dimensional molded product from cellulose pulp, comprising the steps of:
providing a cellulose fiber composition comprising 1-30 wt % lignin, based on the total fiber weight of the composition, said cellulose fiber composition further having a solid content between 0.1-95%;
providing a forming tool having a three dimensional shape including a forming surface, and bringing said forming surface into contact with the cellulose fiber composition;
press drying the cellulose fiber composition contacted by the forming tool at temperatures>200 C to a dry content of at least 70%.

The term “cellulose fiber composition” referred to herein is to be interpreted as a composition comprising natural cellulose-based fibers. Any cellulosic fibers known in the art, including cellulose fibers if any natural origin, such as those derived from wood pulp, can be used in the cellulose composition. Non-limiting examples of cellulosic fibers suitable for use in this invention are cellulose fibers derived from softwoods such as pines, firs and spruces, as well as fibers derived from eucalyptus, bagasse, bamboo and other ligneous and cellulose sources.

Said press drying can be applied in one or several steps depending on the end product. Also, press drying can be done by two complementary forming tools sandwitching and compressing the cellulose fiber to be dried.

According to one aspect of the invention, said cellulose fiber composition is in the form of a pulp suspension of cellulose fiber material having a consistency between 0.1-1% by weight. According to this aspect of the invention, said forming tool is brought into contact with said pulp suspension in such a way that the forming surface of said forming tool is covered with a layer of pulp from said pulp suspension. The forming tool can be brought into contact with the said pulp suspension by means of immersion into the suspension, whereupon cellulose fibers from the suspension are drawn onto the forming surface by means of vacuum suction. Next, the layer of pulp present on said forming surface is press-dried under elevated temperatures and dewatered to a dry content of at least 70%.

According to a preferred aspect of the invention, said pulp is mechanical pulp selected from the group comprising TMP, CMP, CTMP, cTMP, HTCTMP and mixtures thereof. It is understood that other cellulosic material such as chemical or semi-chemical pulp of wood or non-wood material can be added as part of the pulp stock.

According to another aspect of the invention, said cellulosic fiber composition is a fiber based sheet material having a solid content of 30-95%. Preferably, the fiber based sheet is made from mechanical pulp selected from the group comprising TMP, CMP, CTMP, cTMP, HTCTMP and mixtures thereof. According to this aspect, the end-product is made by wetting the sheet so that it acquires a water content between 10-40%, and then stretch-forming the wetted sheet under elevated temperature using a pressing tool. Said “elevated temperature” is here to be interpreted as temperatures>200° C.

According to the invention, lignin containing pulp is used for manufacturing the end-product. Lignin is a major component of fiber materials in addition to cellulose and hemicellulose. Lignin has a hydrophobic nature, which is generally considered unfavorable for paper and board making where hydrophilic feature is required for hydrogen bonding in water environment of paper making. As known by the skilled person, the strength of chemical pulps is achieved by removing lignin from the fiber matrix thus achieving good bonding. It has now surprisingly been found that at escalated temperature, such as temperatures above 200° C., preferably above 250° C., or above 280° C., good bonding can be achieved also with lignin rich fibers when wet fibers or fibers with sufficient moisture are compressed together such as in a thermoforming molding process. Application of sufficiently high temperature during press molding of lignin-containing cellulose fibers having a certain moisture has been observed to result in plasticization of the lignin leading to improved mechanical properties of the end material.

Thanks to the invention, there is thus provided a method for forming three dimensional fiber based products using pulp with lignin content. Contrary to this finding, mechanical pulp fibers are traditionally regarded as less suitable for making packaging products because of low mechanical strength. However, by means of the method of the invention, mechanical pulp fibers can be used as main component in fiber molding manufacturing without the need for adding reinforcement pulp and strength chemicals to achieve acceptable mechanical properties. Also, mechanical pulp is less expensive compared to chemical pulp fibers leading to lower production costs, as well as improved material efficiency because over 90% of raw material (wood or non-wood) can be used compared to only 45-50% in the case of chemical pulp raw material.

Products made of mechanical pulp fibers have also high bulk, which means if a certain thickness of a product is required, less basis weight is required compared to chemical pulp which has a low bulk. This leads to lower fiber cost and lowered energy consumption in the drying step.

According to one aspect of the invention, the fibers to be used in said cellulose fiber composition are selected from the group comprising wood pulps, non-wood pulps, unbleached chemical pulp, defibrated fiber material, bagasse, straws, bamboo, spruce CTMP, eucalyptus CTMP, and spruce HT CTMP.

According to yet another aspect of the invention, said pulp suspension of cellulose fiber material has been subjected to treatment with an oxidant for inducing radicals in the cellulose fiber molecules to induce covalent cross bindings.

According to yet another aspect of the invention, said oxidant is ozone gas or ozone water.

According to yet another aspect of the invention, said pulp suspension of cellulose fiber material has been subjected to treatment with laccase enzyme for cross linking lignin polymers present in said suspension.

The invention also relates to a three dimensional fiber based product obtainable by means of a method as previously described. The fiber based material of said product comprises a density of less than 650 kg/m3, and a bending stiffness greater than 0.8 Nm7/kg3, preferably greater than 1 Nm7/kg3.

According to one aspect of the invention, the fiber based material of said product comprises a burst greater than 1, preferably greater than 1.5 kPam2/g.

According to one aspect of the invention, the fiber based material of said product comprises a Z-strength greater than 200 kPa, preferably greater than 250 kPa.

According to one aspect of the invention, the fiber based material of said product comprises a compressive strength greater than 15 Nm/g, preferably greater than 20 Nm/g.

According to one aspect of the invention, the product obtained by means of the described method is for use as a food packaging product.

### DESCRIPTION OF EMBODIMENTS

The present description is directed to a thermoforming method for manufacturing a molded pulp product from a lignin-containing cellulose fiber composition. Examples of “lignin-containing fiber composition” are mechanical pulp such as thermomechanical pulp (TMP), chemi mechanical pulp (CMP), chemi-thermomechanical pulp (CTMP), cTMP, high-temperature chemithermomechanical pulp (HTCTMP) and mixtures thereof.

Other cellulosic material such as chemical or semi-chemical pulp of wood or none-wood material can also be added as a part of the fiber composition.

Thermoforming refers to a fiber molding method where press forming is combined with application of heat so that the product is densified and dried. Press forming (here also referred to as press drying) may be performed by means of providing two complementary forming tools, a first and a second tool, arranged to essentially match each other, and pressing the two tools together such that the cellulose fiber composition is sandwiched between the first and the second tool. The press forming can be applied in one or several consequtive steps depending on the end product. For example, a two-step press forming could be advantageous to obtain a product with double sided smooth surface.

The present invention covers at least two options for performing thermoforming: wet forming and dry forming.

An example of wet forming a fiber product by means of thermoforming according to the invention is now to be described.

A cellulose fiber composition in the form of a pulp suspension containing mechanical pulp is provided, said pulp suspension having a consistency between 0.1-1% by weight. The pulp suspension is herein referred to as one example of a “cellulose fiber composition”. A three dimensional forming tool arranged on a tool holder is immersed into said suspension thus contacting the pulp therein so that at least a forming surface of said forming tool is covered with a layer of pulp from said pulp suspension. The layer of pulp on the tool can be accomplished in various ways, e.g. by means of applying a suction through the forming tool when it is immersed in the pulp suspension. The layer of pulp present on said forming tool is then press dried at temperatures above 200° C., or above 250° C., such as above 280° C., and simultaneously dewatered to a dry content of at least 70% by weight.

During the press drying step of the method, the pulp layer is subjected to high temperatures above 200° C., such as above 250° C., for instance by means of drying between hot tools in one or several steps with the help of vacuum and compressed air. This leads to efficient and quick drying, as the water present in the pulp is pressed out in combination with being evaporated, which in turn gives better productivity. The applied high temperature also leads to that the lignin in the pulp is plasticized and cross linked, thus improving strength properties in the end-product.

According to the invention, said pulp suspension comprising cellulose fiber material may be pretreated with an oxidant for inducing radicals in the fiber components to induce covalent cross bondings. Suitable oxidants are ozone gas or ozone water. Another possible way of oxidizing the pulp is pre-treatment with laccase enzyme for cross linking lignin polymers. Oxidizing of the pulp is preferably performed on the so-called start preparation pulp having a consistency between 3-5% by weight. The pulp is thereafter diluted to 0.1-1% by weight and fed into the forming step of the molded fiber line.

An example of dry forming a fiber product by means of thermoforming according to the invention is now to be described.

A fiber based sheet or web is produced from a lignin-containing cellulose material, for example made from mechanical pulp. The fiber based sheet material is herein referred to as one example of a “cellulose fiber composition”.

Said sheet material could comprise hardwood or softwood chemical pulp or mechanical pulps, having a ligning content of 1-30% by weight, and with a basic density of 100-900 kg/m3. The fiber based sheet is dampened so that it acquires a moisture content of between 10-40% by weight, and is thereafter transferred to a forming station. A three dimensional forming tool arranged on a tool holder is provided and brought into contact with the dampened sheet. Thermomolding is then performed by pressing the forming tool against the sheet under heat treatment so that the sheet is shaped in accordance with the three dimensional surface of the forming tool. A second mating tool can be used for sandwiching the sheet layer during press forming. Analogously with the wet forming, during the press drying step of the method the sheet is subjected to temperatures above 200° C., such as above 250° C. This leads to efficient and quick drying, as the water present in the pulp is pressed out in combination with being evaporated. The applied high temperature also leads to that the lignin in the pulp is plasticized and cross linked, thus improving strength properties in the end-product.

The product formed by means of the molding method of the invention can thus be produced from lignin-containing mechanical pulp, it will have a low density and yet provide good strength and exhibit material properties that are as good as (or even better than) material produced from chemical pulp.

Measurement and Evaluation Methods

The following methods and standards apply both to the definitions of the appended claims and to the measurements performed in the example below.

Drainage resistance: SCAN C19:65

Density (pulp sheet density, table 1): ISO 534:2011

Density (sheet density table 2): ISO 534:2011

Tensile Index: ISO 1924-3:2005

Tensile stiffness index ISO 1924-3:2005

Stretch at break: ISO 1924-3:2005

Tensile energy abs. index: ISO 1924-3:2005

Burst index: ISO 2758:2014

Tear index: ISO 1974:2012

Z-strength: SCAN-P 80:98

Bending resistance: ISO 2493-1:2010

### EXAMPLE

In order to evaluate the quality of the molded fiber product of the invention, a test series was performed in which thermomolded products made from chemical pulp (Ref 1 and Ref 2) were compared with thermomolded products having a lignin content of at least 1 wt % (Samples A, B and C).

Pulp properties such as drainage resistance, strength and density for the different pulp tests (Ref. 1; Ref. 2; Sample A; Sample B; and Sample C) were evaluated. All tests were performed according to the methods and standards as indicated above and all analyses were carried out according to available standards after conditioning at 23° C., 50% RH.

The properties of the pulps used in the molded fiber samples are presented in Table 1, and the tested properties of the molded fiber materials are presented in Table 2.

Product Formation

A slurry was provided for each of Ref. 1-2, and samples A-C respectively. Each slurry had a consistency between 0.3-0.6 wt %.

Said slurry was transferred to a forming section, where a three dimensional forming tool was brought into contact with said slurry.

Said forming tool had a forming surface having a three dimensional tray-like shape, and comprised channels for vacuum suction. By means of vacuum suction, a pulp layer was formed on the forming surface of the tool.

The forming tool comprising the layer of slurry was transferred to a press molding unit where heat was supplied at temperature exceeding 250° C. Press drying was conducted under heat in several steps until the compression-molded fibre product had reached a dry content of at least 70%.

The measured handsheet properties of the pulp suspensions as well as the resulting molded fiber products are presented in Tables 1 and 2 respectively.

TABLE 1
Pulp properties of tested pulps.

| Property | Unit | Ref 1 | Ref 2 | A | B | C |
|---|---|---|---|---|---|---|
| Sample description | | BI Chem | BI Chem | Spruce | Spruce | Eucalyptus |
| | | Pine pulp | Eucalyptus | CTMP | HT | CTMP |
| | | | pulp | | CTMP | |
| Lignin content | % | <1 | <1 | 27 | 27 | 25 |
| Drainage | °SR | 20.8 | 35 | 15.6 | 17.8 | 30.4 |
| resistance, SR | | | | | | |
| Sheet density | kg/m3 | 728 | 670 | 276 | 364 | 452 |
| Tensile index | Nm/g | 75.04 | 59.16 | 23.61 | 22.43 | 34.4 |
| Tensile stiffness | kNm/g | 7.82 | 7.26 | 2.94 | 3.29 | 4.56 |
| index | | | | | | |
| Stretch at break | % | 3.72 | 3.03 | 1.46 | 1.46 | 1.53 |
| Tensile energy | J/g | 1.93 | 1.29 | 0.22 | 0.23 | 0.35 |
| absorption index | | | | | | |
| Burst index | kPam2/g | 3.8 | 5.89 | 1.39 | 1.2 | 1.55 |
| Tear index | mNm2/g | 11.6 | 8.3 | 12.2 | 7.8 | 4.7 |
| Z-strength | kPa | 530 | 520 | 88 | 118 | 235 |
| FT* average length | mm | 2.111 | 0.785 | 1.886 | 1.373 | 0.88 |
| (>0.2 mm) | | | | | | |
| Coarseness on | mg/m | 181.4 | 78.4 | 335.6 | 302.3 | 119.1 |
| fibers (>0.2 mm) | | | | | | |
| FT + Fiber width | μm | 30.8 | 18 | 37.6 | 37.2 | 21.1 |
| (>0.2 mm) | | | | | | |

*FT = Fibertester, an instrument for fiber testing; (>0.2 mm): a standard method to exclude fractions smaller than 0.2 mm in the test method. CTMP = Chemi-thermomechanical pulp

TABLE 2
Product properties of molded fiber

| Property | Unit | Ref 1 | Ref 2 | A | B | C |
|---|---|---|---|---|---|---|
| Sample description | | BI Chem | BI Chem | Spruce | Spruce | Eucalyptus |
| | | Pine pulp | Eucalyptus | CTMP | HT | CTMP |
| | | | pulp | | CTMP | |
| Sheet density | kg/m3 | 603 | 535 | 496 | 462 | 534 |
| Tensile index | Nm/g | 51.1 | 38.4 | 34.9 | 33.9 | 46.71 |
| Tensile stiffness | kNm/g | 5.130 | 5.600 | 4.910 | 4.380 | 5.75 |
| index | | | | | | |
| Stretch at break | % | 4.110 | 1.990 | 1.480 | 1.460 | 1.82 |
| Tensile energy | J/g | 1.48 | 0.56 | 0.35 | 0.33 | 0.59 |
| absorption index | | | | | | |
| Burst index P25 | kPam2/g | 4.57 | 2.23 | 1.82 | 2.07 | 2.17 |
| Z-strength | kPa | 377 | 372 | 310 | 265 | 369 |
| SCT index | Nm/g | 22.5 | 21.8 | 21.6 | 18.4 | 28.3 |
| Bending | Nm7/kg3 | 0.80 | 0.90 | 1.10 | 1.20 | 1.3 |
| stiffness index | | | | | | |
| 50 mm 15° | | | | | | |

In table 1 it is shown that samples A, B and C have much lower mechanical strength, especially Z-strength, burst strength and tensile stiffness, compared to Ref 1 and Ref 2 both comprising chemical pulp.

As seen in Table 2, however, the molded fiber products made of samples A, B and C, however, have dramatically improved mechanical strength. Not only Z-strength, burst and tensile stiffness are improved to the same level as Ref 1 and Ref 2, but also the products have significantly higher bending stiffness. Sample C has a bending stiffness index which is 40% larger than for Ref 2 at similar mechanical strength, despite the significantly lower mechanical strength of the pulp material. Both Sample C and Ref 2 are produced from eucalyptus as raw wood material.

The strength properties of mechanical pulp products are comparable to, or even higher than properties of chemical pulp products. This is due to the improved consolidation and bonding of the lignin containing fibers at the elevated temperature. The effect of the high temperature treatment is softening of the fiber structure. This in turn improves consolidation and bonding Z strength and tensile strength of the product.

Also, thanks to the high stiffness of the mechanical pulp fibers, the CTMP based products have much better bending stiffness, enabling for reduce basis weight—i.e. resulting in source reduction.

The present invention has been described with regard to preferred embodiments. However, it will be obvious to a person skilled in the art that a number of variations and modifications can be made without departing from the scope of the invention as described herein.

1. A method for producing a three dimensional molded product from cellulose fibers, comprising the steps of:
providing a cellulose fiber composition comprising 1-30 wt % lignin, said cellulose fiber composition further having a solid content between 0.1-95%;
providing a forming tool having a three dimensional shape including a forming surface, and bringing said forming surface into contact with the cellulose fiber composition; and
press drying the cellulose fiber composition contacted by the forming tool at temperatures>200° C. to a dry content of at least 70%.

2. The method according to claim 1, wherein said cellulose fiber composition is a pulp suspension of cellulose fiber material having a consistency between 0.1-1 wt %, and
wherein said forming tool is brought into contact with said pulp suspension so that said forming surface of said forming tool is covered with a layer of pulp from said pulp suspension, whereafter the layer of pulp present on said forming tool is press-dried and dewatered to a dry content of at least 70 wt %.

3. The method according to claim 1, wherein said cellulosic fiber composition is a fiber based sheet material having a solid content of 30-95 wt %.

4. The method according to claim 1, wherein said cellulose fiber composition comprises mechanical pulp selected from a group consisting of: TMP, CMP, CTMP, cTMP, HTCTMP and mixtures thereof.

5. The method according to claim 1, wherein said cellulose fiber composition is selected from a group consisting of: wood pulps, non-wood pulps, unbleached chemical pulp, defibrated fiber material, bagasse, straws, bamboo, spruce CTMP, eucalyptus CTMP, and spruce HT CTMP.

6. The method according to claim 1, wherein the cellulose fiber composition is press dried at temperatures>250° C.

7. The method according to claim 1, wherein at least a portion of the fibers in the cellulose fiber composition have been subjected to treatment with an oxidant for inducing radicals in the cellulose fiber molecules to induce covalent cross bindings.

8. The method according to claim 7, wherein said oxidant is ozone gas or ozone water.

9. The method according to claim 1, wherein at least a portion of the fibers in the cellulose fiber composition have been subjected to treatment with laccase enzyme for cross linking lignin polymers present in said suspension.

10. A three dimensional fiber based product obtained by the method according to claim 1, said product comprising:
a fiber based material having a density of less than 650 kg/m³, and a bending stiffness index greater than 0.8 Nm 7/kg³.

11. A three dimensional fiber based product obtained by the method according to claim 1, said product comprising:
a fiber based material having a density<650 kg/m³.

12. The product according to claim 10, comprising a burst greater than 1 kPam²/g.

13. The product according to claim 10, comprising a Z-strength greater than 200 kPa.

14. The product according to claim 10, comprising a compressive strength greater than 15 Nm/g.

15. The product according to claim 1, wherein the product comprises a food packaging product.
